(19) United States
(12) Patent Application Publication
(10) Pub. No.: US 2017/0311748 A1
(43) Pub. Date: Nov. 2, 2017

(54) HYDROGEN INJECTION APPARATUS

(71) Applicant: Takashi TAKEHARA, Osaka (JP)

(72) Inventor: Takashi TAKEHARA, Osaka (JP)

(21) Appl. No.: 15/517,896

(22) PCT Filed: Oct. 7, 2015
(86) PCT No.: PCT/JP2015/078487

§ 371 Date: Apr. 7, 2017

(30) Foreign Application Priority Data
Oct. 17, 2014 (JP) 2014-212800

(51) Int. Cl. A47J 31/40; A47J 31/46; C02F 1/00

(52) U.S. Cl. CPC A47J 31/40; C02F 1/001; A47J 31/467; C01B 2203/02; C01B 2203/1041

(57) ABSTRACT

The present invention proves a hydrogen injection apparatus that is good in terms of work efficiency and sanitation at the time of maintenance and that is capable of generating hydrogen water the hydrogen content of which is flexibly adjustable. The hydrogen injection apparatus according to the present invention includes a reference vessel, on the bottom of which a particle having a material for reacting with water to generate hydrogen formed on the surface thereof is placed, the reference vessel being configured to store water for reaction with hydrogen, a communication means for fluidly connecting the interior of the upper side of the reference vessel to the storage water for drinking in the state in which the reference vessel is sealed, and an auxiliary means for increasing injection of hydrogen into the storage water for drinking from the reference vessel through the communication means.

### TECHNICAL FIELD

The present invention relates to a hydrogen injection apparatus that is capable of injecting additional hydrogen into a general-purpose water server, a gallon tank, etc.

### BACKGROUND ART

In recent years, water servers capable of providing purified water or natural water have spread to companies, sports facilities, and even homes as the result of the enlargement of the drinking water market. Consequently, the water quality of drinking water desired by users has diversified. In particular, so-called “hydrogen water,” which contains a large amount of hydrogen, has lately attracted attention, and the demand for such hydrogen water for drinking has increased in the sports industry, the medical world, etc., since hydrogen water is effective in removing active oxygen, which causes cancer and various other kinds of diseases. A hydrogen water generator using a chemical reaction between magnesium particles and water has been proposed. Specifically, the hydrogen water generator is disposed in a water server to provide hydrogen to water stored in the water server, thereby generating hydrogen water.

In the above water server type hydrogen water generator, in which specific magnesium particles react with water to generate hydrogen (Mg+2H₂O→Mg(OH)₂+H₂), however, the amount of hydrogen that is generated is limited. For this reason, maintenance, such as exchange, is required every consumption period. At the time of maintenance, the used hydrogen water generator is removed from a drinking water tank of the water server, and a new hydrogen water generator is disposed in the drinking water tank of the water server, with the result that work is troublesome and unsanitary. In addition, it is difficult to sequentially adjust the amount of hydrogen that is injected, since the amount of hydrogen that is generated depends on the above chemical formula. For example, it is not possible to generate hydrogen water within a short time by injecting a large amount of hydrogen to drinking water immediately after the drinking water is supplied into the water server or to adjust or increase the content of hydrogen in the hydrogen water. A hydrogen cylinder may be directly connected to the water server in order to generate hydrogen water within a short time. However, it is required to pay a lot of attention to the handling and storage of the hydrogen cylinder. Furthermore, there is a great risk of the hydrogen cylinder exploding if it catches fire.

### RELATED ART DOCUMENT

### Patent Document

[Patent Document 1] Japanese Patent Application Publication No. 2007-167696

[Patent Document 2] Japanese Patent Application Publication No. 2004-41949

### DISCLOSURE OF THE INVENTION

### Problem to be Solved by the Invention

Therefore, the present invention has been made in view of the above problems, and it is an object of the present invention to provide a hydrogen injection apparatus that is good in terms of work efficiency and sanitation at the time of maintenance and that is capable of generating hydrogen water, the hydrogen content of which is flexibly adjustable.

### Meaning for Solving the Problem

The present invention provides a hydrogen injection apparatus for injecting additional hydrogen (hereinafter, also referred to as “hydrogen gas” as previously described) into storage water for drinking. The hydrogen injection apparatus includes a reference vessel, on the bottom of which a particle having a material for reacting with water to generate hydrogen formed on the surface thereof is placed, the reference vessel being configured to store water for reaction with hydrogen, a communication means for fluidly connecting the interior of the upper side of the reference vessel to the storage water for drinking in the state in which the reference vessel is sealed, and an auxiliary means for increasing the injection of hydrogen into the storage water for drinking from the reference vessel through the communication means.

The hydrogen injection apparatus according to the present invention includes a hydrogen gas generator (the reference vessel) and an auxiliary increasing vessel for increasing the amount of hydrogen that is generated by the hydrogen gas generator, in addition to a vessel for storing drinking water. That is, the hydrogen injection apparatus according to the present invention further includes “separate” devices in order to inject hydrogen into an existing water server or hydrogen water server and to increase the amount of hydrogen that is injected thereinto. Consequently, maintenance is completed by exchanging the “separate” devices or exchanging reaction materials in the “separate” devices, thereby improving work efficiency and improving sanitation at the time of work. In the hydrogen injection apparatus according to the present invention, the “separate” devices include a hydrogen gas generator (the reference vessel), which is normally used, and an auxiliary increasing vessel, which is used to increase the amount of hydrogen that is generated. The content of hydrogen in the water server may be flexibly changed depending on where hydrogen is to be injected.

In addition, the communication means of the hydrogen injection apparatus according to the present invention may be a duct for enabling a hydrogen injection channel from the reference vessel to the storage water for drinking to diverge into a normal channel and an auxiliary increasing channel, and the auxiliary means may include an auxiliary increasing vessel for storing an auxiliary material having greater reactivity to generate hydrogen than the particle placed in the reference vessel, an introduction device for introducing water into the reference vessel from the auxiliary increasing vessel, and a switching valve for switching the normal channel of the duct to the auxiliary increasing channel to inject water into the storage water for drinking in conjunction with the operation of the introduction device.

In addition, the auxiliary material stored in the auxiliary increasing vessel may include a plurality of particles having magnesium coated on the surface of each thereof. Alternatively, the auxiliary material stored in the auxiliary increasing vessel may include a plurality of particles for performing reaction to generate hydrogen using an aluminum hydride component formed on the surface of each thereof.

Various reactions may be performed in order to generate hydrogen. A representative example of the conventional hydrogen generator is configured to generate hydrogen using magnesium in consideration of reaction stability and reaction time. Meanwhile, a hydrogen generation reaction using aluminum powder, a description of which will follow, is effective and stable in increasing the amount of hydrogen that is generated. In addition, in the future, there is a possibility of providing a hydrogen generation reaction for additional drinking water. In general, however, reaction heat may be inevitably large or the reaction time of a reaction material may be short in a reaction for generating a large amount of hydrogen (the same applies to the aluminum reaction).

Meanwhile, water containing hydrogen is water in which the initial amount of hydrogen varies. For example, the concentration of hydrogen differs depending on the material of a vessel, the time for which the vessel is left, the amount of new moisture that is injected, etc., and the amount of hydrogen sequentially differs until a predetermined concentration of hydrogen is reached. In addition, a desired amount of hydrogen differs depending on the purpose of use of the water containing hydrogen. The hydrogen injection apparatus according to the present invention is configured to flexibly solve the above problems. The hydrogen injection apparatus according to the present invention is capable of providing storage water for drinking by appropriately switching between a normal channel, through which a predetermined amount of hydrogen is supplied for a long time, and an auxiliary channel, through which the amount of hydrogen is rapidly increased. In addition, the (above) problem in the generation reaction of hydrogen transferred along the auxiliary channel is temporarily selected, but the normal channel generally has priority in the hydrogen injection apparatus according to the present invention. However, the above problem is not serious. In other words, the hydrogen injection apparatus according to the present invention is characterized in that it is possible to change the amount of hydrogen in response to the desired content of hydrogen in drinking water and to offset disadvantages in various hydrogen generation reactions.

In addition, the communication means may include a duct defining a hydrogen injection channel from the reference vessel to the storage water for drinking, the duct being connectable to a gallon tank for storing drinking water, and a discharge member connected to the duct while extending to the lower side of the gallon tank for discharging hydrogen into the drinking water, and the auxiliary means may include an auxiliary increasing vessel for storing an auxiliary material having greater reactivity to generate hydrogen than the particle placed in the reference vessel and an introduction device for introducing water into the reference vessel from the auxiliary increasing vessel.

A large number of conventional special-purpose hydrogen water generators are available, and it is necessary for a user who wishes to drink hydrogen water to install a “separate” hydrogen water generator, which is troublesome, increases costs, and requires an installation space. As a result, the enlargement of the hydrogen water market to the existing water server market is difficult. In contrast, the hydrogen injection apparatus according to the present invention may be mounted to a water server having a general-purpose gallon tank in the existing water server market. Consequently, it is not necessary to newly provide a special-purpose hydrogen water generator in order to satisfy the demand of users who wish to easily drink hydrogen water at a low price.

In addition, storage water for drinking may be injected from a gallon tank that is fluidly connected to a water injection port formed in the upper part of a vessel for storing the storage water for drinking, and the communication means may include a duct defining a channel for directly injecting hydrogen into the storage water for drinking from the reference vessel and the water injection port. In addition, the auxiliary means may include an auxiliary increasing vessel for storing an auxiliary material having greater reactivity to generate hydrogen than the particle placed in the reference vessel and an introduction device for introducing water into the reference vessel from the auxiliary increasing vessel. In addition, the auxiliary material stored in the auxiliary increasing vessel may include a plurality of particles having magnesium coated on the surface of each thereof or aluminum hydride (AlH₃).

As previously described, the hydrogen injection apparatus according to the present invention is configured to directly inject hydrogen into storage water for drinking from the reference vessel and to additionally inject hydrogen that has not been contained in the storage water for drinking (i.e. residual hydrogen) into a gallon tank for replenishment installed at the upper part thereof. As a result, it is possible to convert the water in the gallon tank for replenishment into hydrogen water and to increase the initial amount of hydrogen that is contained in the replenishment water in the gallon tank. Consequently, the necessity for injecting a large amount of hydrogen after filling the vessel for storing the storage water for drinking with replenishment water is reduced, whereby it is possible to provide a large amount of hydrogen water at once.

Furthermore, the present invention provides a hydrogen injection apparatus for injecting additional hydrogen into a gallon tank filled with storage water for drinking, the hydrogen injection apparatus including a sealed vessel unit, on the bottom of which a particle having a material for reacting with water to generate hydrogen formed on the surface thereof is placed, the vessel unit being configured to store water for reaction with hydrogen, a hollow cylinder member extending vertically from the upper side of the interior of the vessel unit through the bottom thereof, the hollow cylinder member being provided in the vicinity of the upper end thereof with a hole for suctioning an atmosphere in the vessel unit, a piston member slidable upward and downward in the hollow cylinder member, a pressing means for sliding the piston member downward, an elastic member for sliding the piston member, having been slid downward, upward to restore the piston member, a hydrogen injection member fluidly connected to the cylinder member, the hydrogen injection member extending to the storage water for drinking in the gallon tank, and a fixing means for positioning the upper part of the gallon tank at the bottom of the vessel unit, wherein, when the pressing means is pushed, the piston member is slid downward, whereby the atmosphere in the cylinder member is transferred to the hydrogen injection member. The particle may include a plurality of particles having magnesium coated on the surface of each thereof.

In the hydrogen injection apparatus according to the present invention, the vessel unit for generating hydrogen is directly connected to the gallon tank filled with storage water for drinking. Consequently, it is possible to miniaturize the hydrogen injection apparatus according to the present invention, as compared with a general-purpose stationary water server. In addition, it is possible to directly convert the storage water for drinking in the gallon tank into water containing hydrogen. For example, it is possible to store the storage water for drinking in the gallon tank in the state of being converted into hydrogen water and to immediately or rapidly provide hydrogen water when the gallon tank is exchanged.

### BRIEF DESCRIPTION OF THE DRAWINGS

FIG. 1 is a schematic view showing a water server type hydrogen water generator according to an embodiment of the present invention;

FIG. 2 is a schematic view showing a hydrogen water generation vessel according to another embodiment of the present invention;

FIG. 3 is a schematic view showing a hydrogen water generation vessel according to another embodiment of the present invention, wherein FIG. 3(a) is an assembled view and FIG. 3(B) is a development view; and

FIG. 4 is a schematic view showing a hydrogen water generation vessel according to a further embodiment of the present invention.

### BEST MODE FOR CARRYING OUT THE INVENTION

An embodiment of a hydrogen injection apparatus according to the present invention will be described.

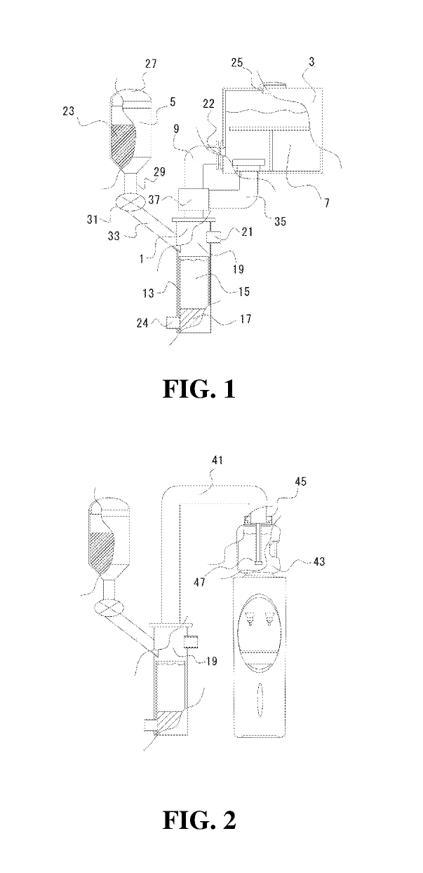

FIG. 1 is a schematic view showing an example of the hydrogen injection apparatus according to this embodiment (in this figure, each wavy line indicates the interface between the external appearance and the cross section of a member, which is equally applied to other figures). The hydrogen injection apparatus shown in FIG. 1 generally includes a hydrogen generation tank 1, which serves to generate hydrogen, a tank 3 provided in a server for storing storage water for drinking (hereinafter, also simply referred to as “drinking water”), and an aluminum powder storage layer 5, which is used to accelerate the generation of hydrogen.

The hydrogen generation tank 1 is configured in the form of a box that has a vessel 13, which is open upward, disposed therein. In the vessel 13 are received reaction water 15 and ball-shaped magnesium particles 17, the surface of each of which is plated with magnesium, the surface of each of the ball-shaped magnesium particles 17 reacting with the reaction water 15 to generate hydrogen. In addition, the vessel 13 is provided in one side of the lowermost part thereof with a drain 24, which extends from the vessel 13 through the hydrogen generation tank 1 so as to communicate with the outside such that the reaction water 15 is drained after the use thereof. In addition, the vessel 13 is provided in the upper side thereof with a space 19 for temporarily storing hydrogen generated by the reaction water 15 and the magnesium particles 17. The space is provided in one side thereof with a reaction tap water injection port 21, which extends through the hydrogen generation tank 1, such that the hydrogen generation tank 1 can be replenished with the water 15 from outside through the reaction tap water injection port 21.

Hydrogen (having the reaction formula of Mg+2H₂O→Mg(OH)₂+H₂) generated in the vessel 13, which is disposed in the hydrogen generation tank 1, rises to the space 19, and then passes through the upper surface of the hydrogen generation tank 1 from the space 19. Subsequently, the hydrogen passes through a normal duct 9, which is connected to one side of the tank 3 provided in the server, and is then introduced into the tank 3 provided in the server. A fluorine film 22 having a diameter of 50 mm is provided at the coupling part of the normal duct 9 and the tank 3 provided in the server such that only hydrogen is transferred from the normal duct 9 to the tank 3 provided in the server and such that drinking water 7 in the tank 3 provided in the server is prevented from flowing backward to the normal duct 9. In addition, a check valve is provided at the coupling part of the tank 3 provided in the server and the normal duct 9 such that hydrogen flows into only the tank 3 provided in the server and such that the water 7 in the tank 3 provided in the server is prevented from flowing backward to the normal duct 9, in the same manner as the fluorine film 22. In the tank 3 provided in the server is stored drinking water 7 injected through a drinking water injection port 25 provided in the upper surface of the tank 3 provided in the server. The hydrogen introduced into the tank 3 provided in the server is mixed with the drinking water 7.

In addition, the aluminum powder storage layer 5 is provided at the upper surface thereof with a lid 27, which is configured to be opened. The lid 27 is opened, and then aluminum powder 23 (A1l-1₃) is introduced into the aluminum powder storage layer. The aluminum powder 23 accelerates the generation of hydrogen in the hydrogen generation tank 1. In addition, the lower surface of the aluminum powder storage layer 5 communicates with an aluminum powder filling device 31, which is configured to control the amount of aluminum powder 23 to be filled, via a dropping duct 29. Consequently, the aluminum powder 23 is transferred into the aluminum powder filling device 31 via the dropping duct 29. A predetermined amount of aluminum powder 23 set by the aluminum powder filling device 31 is introduced into the vessel 13 from the lower surface of the aluminum powder filling device 31 via an aluminum powder guide duct 33, which is connected to one side of the hydrogen generation tank 1, and reacts with the reaction water 15 to accelerate the generation of hydrogen (2AlH₃+3H₂O→Al₂O₃+6H₂).

In addition, in the case in which the generation of hydrogen is accelerated using the aluminum powder 23, hydrogen is transferred into the tank 3 provided in the server through a channel using a turbo duct 35 (hereinafter, also referred to as a “turbo channel”), rather than through a channel from the normal duct 9 to the tank 3 provided in the server (hereinafter, also referred to as a “normal channel”). The turbo duct 35 diverges from the normal duct 9 via a switching valve 37 provided in the normal duct 9. Switching between the normal channel and the turbo channel is performed by the operation of the switching valve 37. In addition, the switching valve 37 is operated while being synchronized with the aluminum powder filling device 31 when the aluminum powder 23 is introduced into the vessel 13. In addition, a check valve is also provided at the connection part of the turbo duct 35 and the tank 3 provided in the server such that hydrogen flows into only the tank 3 provided in the server and such that the water 7 in the tank 3 provided in the server is prevented from flowing backward to the turbo duct 35.

A hydrogen generation bubbling port 39 is provided at the coupling part of the turbo duct 35 and the tank 3 provided in the server, unlike the coupling part of the normal duct 9 and the tank 3 provided in the server. Hydrogen to be introduced into the tank 3 provided in the server from the turbo duct 35 is converted into micro bubbles while passing through the hydrogen generation bubbling port 39. As a result, the hydrogen can be more efficiently mixed with the drinking water 7 than when the hydrogen passes through the normal duct 9.

Next, referring to FIG. 2, there is shown a hydrogen injection apparatus according to another embodiment of the present invention. FIG. 2 is a schematic view showing the case in which the hydrogen injection apparatus according to this embodiment uses a conventional water server in place of the tank 3 provided in the server described above. It is preferable to use a water server having a basic structure, in which a gallon tank 43 is provided at the upper part of the water server. The end of a connection duct 41, which is connected to the space 19 in the hydrogen generation tank 1, is inserted into the drinking water tank of the conventional water server through the upper surface thereof, and the connection duct 41 and the gallon tank 43 are connected to each other using a connector 45, which is provided at the coupling part of the connection duct 41 and the gallon tank 43. In addition, the end of the connection duct is provided with a connection hydrogen generation bubbling port for converting hydrogen into micro bubbles, in the same manner as the hydrogen generation bubbling port 39.

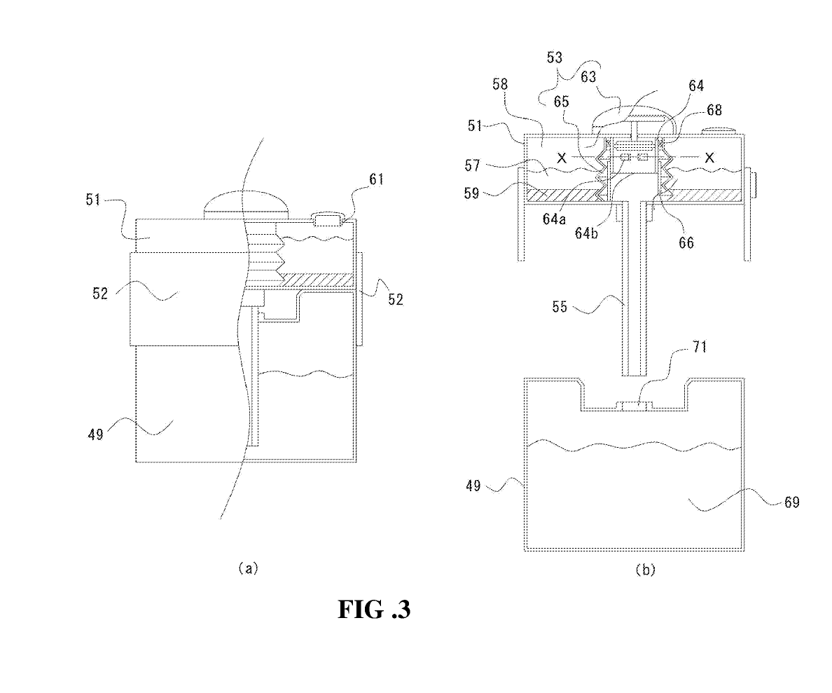

Next, FIGS. 3(a) and 3(b) are schematic views showing a water server type hydrogen water generator according to another embodiment of the present invention. A gallon tank 49, which is generally configured in the form of a gallon tank, may be combined with a simplified small-sized hydrogen gas generation tank 51. A fixing stay 52 is installed at the outer circumference of the lower part of the small-sized hydrogen gas generation tank 51, and the upper surface of the gallon tank 49 is covered with the lower surface of the small-sized hydrogen gas generation tank 51, at which the fixing stay 52 is installed. The interior of the small-sized hydrogen gas generation tank 51 is hollow. A pump 53 is connected to the small-sized hydrogen gas generation tank 51 in the state of extending from the center of the upper surface thereof to the center of the lower surface thereof. A hydrogen gas guide pipe 55 is connected to the lower end of the pump 53. In the small-sized hydrogen gas generation tank 51 are received reaction water 57 and ball-shaped magnesium particles 59, which react with the reaction water 57 to generate hydrogen. In addition, the small-sized hydrogen gas generation tank 51 is provided in the upper surface thereof with a reaction tap water injection port 61, which communicates with the outside, such that the small-sized hydrogen gas generation tank 51 can be replenished with the reaction water 57 from outside through the reaction tap water injection port 61.

Hereinafter, the process of injecting hydrogen into drinking water from the pump 53 will be described. The pump 53 is configured such that a piston 64 is disposed in the lower side of a pressing part 63 of an elastic resin member protruding upward in an arc shape. The piston 64 slides in a cylinder 66, which is vertically disposed in a bellows part 65. When the pressing part 63 is pushed downward by the pressure of a hand, therefore, the piston 64 slides downward, with the result that hydrogen 58 in the cylinder 66 is transferred downward through the hydrogen gas guide pipe 55. In addition, the end of the bellows part 65 is connected to the outer circumference of the piston 64 (see reference numeral 68). Consequently, the bellows part 65 moves upward and downward in conjunction with the movement of the piston 64. When the pressure of the hand applied to the pressing part 63 is released after the hydrogen gas in the cylinder 66 is transferred downward, the bellows part 65 extends upward due to the elastic restoring force thereof. As a result, the piston 64 also moves upward. At this time, negative pressure is generated in the cylinder 66, with the result that it becomes necessary to fill the tank 51 with hydrogen 58.

The piston 64 and the bellows part 65 will be described in more detail. Since the bellows part 65 is not sealed from the outside, the bellows part 65 is filled with hydrogen gas 58. In addition, the piston 64 is provided in the vicinity of the middle thereof with a plurality of holes 64a, which communicate with the bottom surface 64b of the cylinder 64 through the interior of the cylinder 64. When the cylinder 66 slides upward and the holes 64a move beyond the upper end position of the cylinder 66, therefore, the holes 64a are opened into the space in the bellows part 65, with the result that hydrogen gas can be introduced into the cylinder 66. When the pressure of the hand is released and negative pressure is generated in the cylinder 66, therefore, the cylinder 66 is filled with hydrogen gas. The application and release of the pressure of the hand may be repeated to move the piston 64 upward and downward such that hydrogen gas can be transferred downward.

In addition, a check valve is provided at the coupling part of the pump 53 and the hydrogen gas guide pipe 55. The check valve allows hydrogen to flow into only the gallon tank 49 and prevents drinking water 69 in the gallon tank 49 from flowing backward into the pump 53. The gallon tank 49 is provided in the upper surface thereof with a hole 71, through which the hydrogen gas guide pipe 55 is inserted, such that the drinking water 69 in the gallon tank 49 is mixed with hydrogen through the hole 71.

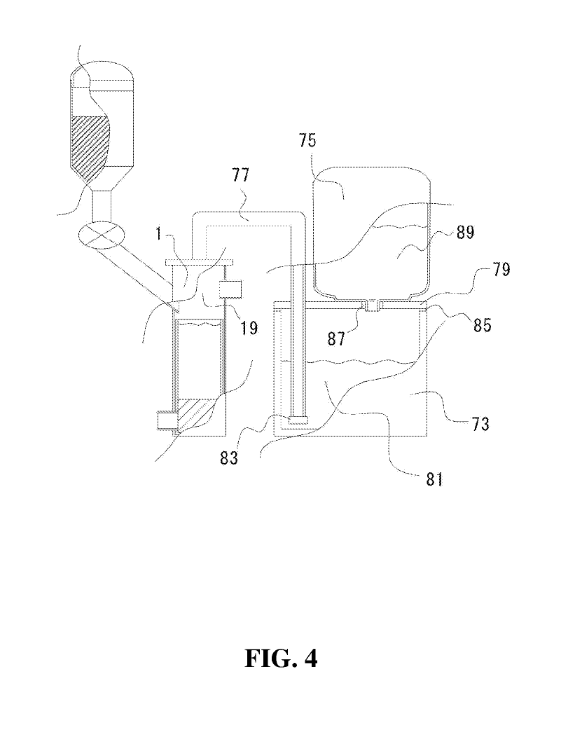

Next, FIG. 4 is a schematic view showing a hydrogen injection apparatus according to a further embodiment of the present invention. In the hydrogen injection apparatus according to this embodiment, a processing type tank 73 provided in a server and a large-sized tank 75 are used in place of the tank 3 provided in the server described above. The large-sized tank 75 is connected to the upper part of the processing type tank 73 provided in the server. In the case in which the processing type tank 73 provided in the server and the large-sized tank 75 are combined with each other, it is possible to supply hydrogen water without frequently replenishing the drinking water even when the demand for hydrogen water is high.

The end of a processing type connection duct 77, which is connected to the space 19 in the hydrogen generation tank 1, is inserted into the processing type tank 73 provided in the server through a canopy 79, which is located at the upper surface of the processing type tank 73 provided in the server. A packing A 85 is provided at the coupling part of the canopy 79 and the processing type tank 73 provided in the server to prevent drinking water 81 and hydrogen in the processing type tank 73 provided in the server from leaking to the outside. In addition, a processing type hydrogen generation bubbling port 83, which provides the same effect as the hydrogen generation bubbling port 39 to the hydrogen, is provided in the end of the processing type connection duct 77. Consequently, hydrogen introduced into the processing type tank 73 provided in the server is efficiently mixed with the drinking water 81 in the processing type tank 73 provided in the server.

The canopy 79, which is located at the upper surface of the processing type tank 73 provided in the server, is connected to the large-sized tank 75, and a packing B 87 is provided at the coupling part of the canopy 79 and the large-sized tank 75. Hydrogen stored in the upper part of the processing type tank 73 provided in the server passes through the coupling part of the processing type tank 73 provided in the server and the large-sized tank 75 and is transferred into the large-sized tank 75 such that the hydrogen is exchanged with drinking water 89 in the large-sized tank 75. Whenever hydrogen is transferred into the large-sized tank 75, the hydrogen is mixed with the drinking water 89 in the large-sized tank 75, and the mixture is transferred into the processing type tank 73 provided in the server. As a result, the processing type tank 73 provided in the server is replenished with the drinking water 89 mixed with the hydrogen whenever the drinking water 81 is consumed.

Although the embodiments of the present invention has been described with reference to the drawings, the present invention is not limited to the embodiments, and those skilled in the art will appreciate that other improvements and modifications are possible, without departing from the scope and spirit of the invention as disclosed in the accompanying claims.

### INDUSTRIAL APPLICABILITY

The hydrogen injection apparatus according to the present invention is good in terms of work efficiency and sanitation at the time of maintenance, and is capable of generating hydrogen water the hydrogen content of which is flexibly adjustable. Specifically, it is possible to use the hydrogen injection apparatus for desired water or solutions containing hydrogen. The hydrogen injection apparatus may be used in a hydrogen water generation server or a general-purpose vessel. For example, the hydrogen injection apparatus may be installed in a vessel for storing face lotion, face wash, or essence in an aesthetic clinic or a beauty parlor, in addition to a hydrogen water server, a gallon tank, or a PET bottle for drinking. In this specification, drinking water means water having low toxicity to a living body, and therefore it is obvious that the hydrogen injection apparatus can be used for cosmetics, etc.

### DESCRIPTION OF REFERENCE NUMERALS

1 Hydrogen generation tank
3 Tank provided in server
5 Aluminum powder storage layer
7 Drinking water
9 Normal duct
13 Vessel
15 Reaction water
17 Magnesium particles
19 Space
21 Reaction tap water injection port
22 Fluorine film
23 Aluminum powder
24 Drain
25 Drinking water injection port
27 Lid
29 Dropping duct
31 Aluminum powder filling device
33 Aluminum powder guide duct
35 Turbo duct
37 Switching valve
39 Hydrogen generation bubbling port
41 Connection duct
43 Gallon tank
45 Connector
47 Connection hydrogen generation bubbling port
49 Gallon tank
51 Small-sized hydrogen gas generation tank
52 Fixing stay
53 Pump
55 Hydrogen gas guide pipe
57 Reaction water
58 Hydrogen
59 Magnesium particles
61 Reaction tap water injection port
63 Pressing part
64 Piston
64a Hole
64b Bottom surface
65 Bellows part
66 Cylinder
69 Drinking water
71 Hole
73 Processing type tank provided in server
75 Large-sized tank
77 Processing type connection duct
79 Canopy
81 Drinking water
83 Processing type hydrogen generation bubbling port
85 Packing A
87 Packing B
89 Drinking water

What is claimed:

1. A hydrogen injection apparatus for injecting additional hydrogen into storage water for drinking, the hydrogen injection apparatus comprising: a reference vessel, on a bottom of which a particle having a material for reacting with water to generate hydrogen formed on a surface thereof is placed, the reference vessel being configured to store water for reaction with hydrogen; a communication means for fluidly connecting an interior of an upper side of the reference vessel to the storage water for drinking in a state in which the reference vessel is sealed; and an auxiliary means for increasing injection of hydrogen into the storage water for drinking from the reference vessel through the communication means.

2. The hydrogen injection apparatus according to claim 1, wherein the communication means is a duct for enabling a hydrogen injection channel from the reference vessel to the storage water for drinking to diverge into a normal channel and an auxiliary increasing channel, and wherein the auxiliary means comprises: an auxiliary increasing vessel for storing an auxiliary material having greater reactivity to generate hydrogen than the particle placed in the reference vessel; an introduction device for introducing water into the reference vessel from the auxiliary increasing vessel; and a switching valve for switching the normal channel of the duct to the auxiliary channel to inject water into the storage water for drinking in conjunction with an operation of the introduction means.

3. The hydrogen injection apparatus according to claim 1, wherein the communication means comprises: a duct defining a hydrogen injection channel from the reference vessel to the storage water for drinking, the duct being connectable to a gallon tank for storing drinking water; and a discharge member connected to the duct while extending to a lower side of the gallon tank for discharging hydrogen into the drinking water, and wherein the auxiliary means comprises: an auxiliary increasing vessel for storing an auxiliary material having greater reactivity to generate hydrogen than the particle placed in the reference vessel; and an introduction device for introducing water into the reference vessel from the auxiliary increasing vessel.

4. The hydrogen injection apparatus according to claim 1, wherein storage water for drinking is injected from a gallon tank that is fluidly connected to a water injection port formed in an upper part of a vessel for storing the storage water for drinking, and wherein the communication means comprises: a duct defining a channel for directly injecting hydrogen into the storage water for drinking from the reference vessel; and the water injection port.

5. The hydrogen injection apparatus according to claim 4, wherein the auxiliary means comprises: an auxiliary increasing vessel for storing an auxiliary material having greater reactivity to generate hydrogen than the particle placed in the reference vessel; and an introduction device for introducing water into the reference vessel from the auxiliary increasing vessel.

6. The hydrogen injection apparatus according to claim 5, wherein the auxiliary material stored in the auxiliary increasing vessel comprises a plurality of particles having magnesium coated on a surface of each thereof.

7. The hydrogen injection apparatus according to claim 5, wherein the auxiliary material stored in the auxiliary increasing vessel comprises a plurality of particles for performing reaction to generate hydrogen using an aluminum hydride component formed on a surface of each thereof.

8. A hydrogen injection apparatus for injecting additional hydrogen into a gallon tank filled with storage water for drinking, the hydrogen injection apparatus comprising: a sealed vessel unit, on a bottom of which a particle having a material for reacting with water to generate hydrogen formed on a surface thereof is placed, the vessel unit being configured to store water for reaction with hydrogen; a hollow cylinder member extending vertically from an upper side of an interior of the vessel unit through a bottom thereof, the hollow cylinder member being provided in a vicinity of an upper end thereof with a hole for suctioning an atmosphere in the vessel unit; a piston member slidable upward and downward in the hollow cylinder member; a pressing means for sliding the piston member downward; an elastic member for sliding the piston member, having been slid downward, upward to restore the piston member; a hydrogen injection member fluidly connected to the cylinder member, the hydrogen injection member extending to the storage water for drinking in the gallon tank; and a fixing means for positioning an upper part of the gallon tank at the bottom of the vessel unit, wherein, when the pressing means is pushed, the piston member is slid downward, whereby an atmosphere in the cylinder member is transferred to the hydrogen injection member.

9. The hydrogen injection apparatus according to claim 8, wherein the particle comprises a plurality of particles having magnesium coated on a surface of each thereof.

10. The hydrogen injection apparatus according to claim 8, wherein the particle comprises a plurality of particles for performing reaction to generate hydrogen using an aluminum hydride component formed on a surface of each thereof.
